(19) United States
(12) Patent Application Publication
(10) Pub. No.: US 2025/0219750 A1
(43) Pub. Date: Jul. 3, 2025

(54) SYSTEM AND METHODS TO CAPTURE AND STREAM MULTIPLE RADIO CHANNELS

(71) Applicant: Anissa Bezanson, Snohomish, WA (US)

(72) Inventors: Matthew Cunningham, Greenwood, IN (US); Samuel Bradley, Fremont, IN (US); Cassten Everidge, Hudson, IN (US)

(21) Appl. No.: 18/398,909

(22) Filed: Dec. 28, 2023

(51) Int. Cl. H04H 20/34; H04H 60/90

(52) U.S. Cl. CPC H04H 20/34; H04H 60/90

(57) ABSTRACT

A system includes a first signal processing subsystem in communication with a first radio receiver and configured to selectively generate audio data of individual radio channels within a first frequency range; a second signal processing subsystem in communication with a second radio receiver and configured to selectively generate audio data of individual radio channels within a second frequency range; and a controller configured to: receive a streaming request from a remote requestor, and configure one of the signal processing subsystems to fulfill the streaming request based on a target radio channel of the streaming request and the associated frequency ranges. In response, the configured signal processing subsystem is configured to fulfill the streaming request by generating audio data of the target radio channel. The generated audio data is then transmitted to a remote recipient.

### BACKGROUND

Radio communication (e.g., the transfer of data using radio waves) remains popular for communicating data across distances and has applications spanning various industries and use cases. In the motorsports industry, for example, radio is commonly used to broadcast commentary during a race so that fans can follow along from anywhere. Motorsport fans are often interested in being able to listen to the radio channels of their favorite drivers and teams, as this content provides access to team strategy, decision-making, and personalities-a nuance that gives deeper color to the sport. Traditionally, to access these communication channels, a fan would have to either buy or rent a radio scanner, as well as ascertain the frequency corresponding to the driver or drivers that they would be interested in.

Given the cost, complexity, and inconvenience of obtaining and operating suitable radio equipment for this purpose, there is interest in making driver and team radio accessible from a smartphone or other portable and readily available device. Some existing solutions capture each driver's radio communication channel via an array of radio receivers, which then port the audio stream over a network as a broadcast. However, this 1:1 relationship between radio receivers to driver channels makes this solution both cost-prohibitive and logistically infeasible for most racing venues. Likewise, these radio arrays are not dynamic-they must be configured manually by an on-site engineer who sets each receiver to the appropriate frequency.

### SUMMARY

One implementation of the present disclosure is a system including: a first signal processing subsystem in communication with a first radio receiver, the first signal processing subsystem configured to selectively generate audio data of individual radio channels within a first frequency range of radio signals captured by the first radio receiver; a second signal processing subsystem in communication with a second radio receiver, the second signal processing subsystem configured to selectively generate audio data of individual radio channels within a second frequency range of radio signals captured by the second radio receiver, the second frequency range different from the first frequency range; and a controller in communication with the first and second signal processing subsystems, wherein the controller is configured to: (i) receive a streaming request from a remote requestor, the streaming request indicating a target radio channel and including instructions for streaming audio data associated with the target radio channel to a remote recipient, and (ii) configure one of the first or second signal processing subsystems to fulfill the streaming request based on the target radio channel and the first and second frequency ranges; wherein, responsive to configuration by the controller, the one of the first or second signal processing subsystems configured to fulfill the streaming request generates audio data of the target radio channel from the radio signals captured by a respective one of the first or second radio receivers, and wherein the generated audio data is transmitted to the remote recipient.

In some implementations of the system, the target radio channel is one of a plurality of predefined target radio channels within a frequency band of interest, wherein prior to receiving the streaming request, the controller is further configured to: parse the frequency band of interest into a plurality of sub-bands according to the plurality of predefined target radio channels, wherein a first one of the plurality of sub-bands defines the first frequency range and a second one of the plurality of sub-bands defines the second frequency range, and wherein each of the plurality of sub-bands includes at least one of the plurality of predefined target radio channels; and configure at least one of: (i) the first radio receiver to capture radio signals in the first one of the plurality of sub-bands, or (ii) the second radio receiver to capture radio signals in the second one of the plurality of sub-bands.

In some implementations of the system, configuring a radio receiver of the plurality of radio receivers according to its respective sub-band includes to: set or adjust a sampling rate of the radio receiver according to a bandwidth of the respective sub-band, wherein a center frequency of the respective sub-band is selected based on one of: (i) an average of any of the plurality of predefined target radio channels in the respective sub-band, or (ii) by minimizing a root mean squared (RMS) error between any of the plurality of predefined target radio channels in the respective sub-band.

In some implementations of the system, responsive to receiving the streaming request, the controller is further configured to: determine a sub-band within a frequency band of interest that includes the target radio channels, wherein the sub-band defines one of the first frequency range or the second frequency range; and configure at least one of the first or second radio receivers to capture radio signals in the sub-band.

In some implementations of the system, the controller is further configured to maintain a registry of active audio streams, including to update the registry when streaming of the audio data from the target radio channel is active.

In some implementations of the system, to generate the audio data, the one of the first or second signal processing subsystems selected to handle the streaming request: isolates a portion of the first or second radio signals associated with the first channel via frequency shifting; demodulates the portion of the first or second radio signals associated with the first channel; and filters the demodulated portion of the of the first or second radio signals.

In some implementations of the system, the instructions include an identifier associated with the remote recipient.

In some implementations of the system, at least one of the first radio receiver or the second radio receiver is a software-defined radio.

In some implementations of the system, the remote recipient is one of an Internet-based audio streaming platform or a personal computing device.

In some implementations of the system, the remote requestor a cloud-based controller.

Another implementation of the present disclosure is method of selectively streaming audio data from multiple radio channels, the method including: continuously capturing, by a plurality of radio receivers, radio signals across a frequency band of interest, each of the plurality of radio receivers configured to capture a subset of the radio signals in a respective sub-band of the frequency band of interest; receiving, from a remote requestor, a streaming request indicating a target radio channel from which audio data is to be generated and streamed; configuring a first signal processing subsystem of a plurality of signal processing subsystems to fulfill the streaming request, wherein each of the plurality of signal processing subsystems is configured to receive a respective subset of the radio signals from a corresponding one of the plurality of radio receivers and selectively generate audio data of individual radio channels within a respective sub-band, and wherein the first signal processing subsystem is configured to fulfill the streaming request based on its respective sub-band and the target radio channel; generating, by the first signal processing subsystem, the audio data of the target channel by, in part, isolating a portion of the subset of the radio signals received by the first signal processing subsystem corresponding to the target channel via frequency shifting; and transmitting the audio data to a remote recipient.

In some implementations of the method, the target radio channel is one of a plurality of predefined target radio channels, the method further including: prior to continuously capturing the radio signals: parsing the frequency band of interest into a plurality of sub-bands according to the plurality of predefined target radio channels; and configuring each of the plurality of radio receivers according to their respective sub-band of the plurality of sub-bands.

In some implementations of the method, configuring a radio receiver of the plurality of radio receivers according to its respective sub-band includes: setting or adjusting a sampling rate of the radio receiver to correspond to a bandwidth of the respective sub-band, wherein a center frequency of the respective sub-band is selected based on one of: (i) an average of any of the plurality of predefined target radio channels in the respective sub-band, or (ii) by minimizing a root mean squared (RMS) error between any of the plurality of predefined target radio channels in the respective sub-band.

In some implementations, the method further includes: responsive to receiving the streaming request, determining a sub-band within a frequency band of interest that includes the target radio channel; and reconfiguring one of the plurality of radio receivers to capture radio signals in the sub-band.

In some implementations, the method further includes maintaining a registry of active audio streams, including updating the registry when streaming of the audio data from the target radio channel is active.

In some implementations of the method, generating the audio data further includes: demodulating the isolated portion of the subset of the radio signals received by the selected signal processing subsystem corresponding to the target channel; and filtering the demodulated portion of the subset of the radio signals received by the selected signal processing subsystem corresponding to the target channel.

In some implementations of the method, the streaming request further includes streaming instructions, the streaming instructions indicating an identifier associated with the remote recipient.

In some implementations of the method, the remote recipient is one of an Internet-based audio streaming platform or a personal computing device.

In some implementations of the method, the remote requestor a cloud-based controller.

Yet another implementation of the present disclosure is system including: at least one radio receiver configured to capture a radio signal that covers a first frequency range; at least one processor; and memory having instructions stored thereon that, when executed by the at least one processor, cause the system to: receive, from a remote requestor, a request to stream audio data from a first channel within the first frequency range, wherein the request includes an identifier of the first channel and instructions for streaming the audio data to a remote recipient; generate the audio data of the first channel from the radio signal by: (i) isolating a portion of the radio signal associated with the first channel via frequency shifting, (ii) demodulating the portion of the radio signal associated with the first channel, and (iii) filtering the demodulated portion of the radio signal associated with the first channel; and transmit the audio data to the remote recipient, wherein the remote recipient is one of a cloud-based audio streaming platform or a user device.

Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a block diagram of a system for capturing and streaming multiple radio channels in a first configuration, according to some implementations.

FIG. 2 is a block diagram of the system for capturing and streaming multiple radio channels in a second configuration, according to some implementations.

FIG. 3 is a diagram of the communication architecture between components of the disclosed system, according to some implementations.

FIG. 4 is a flow chart of a process for dynamically configuring the disclosed system and initiating the extraction of audio data from target channels, according to some implementations.

FIG. 5 is a flow chart of a process for selectively extracting audio data from target channels, according to some implementations.

FIG. 6 is a diagram of an example signal processing technique utilized by the disclosed system, according to some implementations.

FIG. 7 is a diagram of an example radio frequency range denoting a “band-of-interest” and respective sub-bands, according to some implementations.

FIG. 8 is a diagram of one technique for configuring the radio receivers and streaming subsystems of the disclosed system, according to some implementations.

FIG. 9 is a diagram of another technique for configuring the radio receivers and streaming subsystems of the disclosed system, according to some implementations.

FIG. 10 is a diagram of yet another technique for configuring the radio receivers and streaming subsystems of the disclosed system, according to some implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and methods for capturing and streaming multiple radio channels are shown, according to various implementations. At a high level, the system includes one or more radio receivers for capturing radio signals across a band-of-interest (e.g., a frequency range) and an on-site signal processing system configured to extract individual channels-of-interest from the captured radio signals. A command originator can provide requests indicating target channels (e.g., specific radio frequencies) and streaming instructions to the on-site signal processing system. In this regard, the disclosed system can be “remotely” controlled via the command originator, e.g., which may be hosted on a remote device (e.g., in “the cloud”) or which may be local to the system. For example, in some implementations, the command originator may be hosted on a cloud server or otherwise enabled via the “cloud,” thus allowing for remote control of the system.

Target channels or “channels-of-interest,” as discussed herein, generally refer to specific frequencies within a band-of-interest, e.g., associated with a radio broadcast. In motorsport, for example, the target channels can be radio frequencies utilized by each driver or team. As mentioned above, the on-site signal processing system generally “extracts” a target channel by isolating the associated frequency in a captured radio signal and converting the isolated signal data into audio data. The streaming instructions provided by the command originator dictate “where” and/or “how” to broadcast the audio generated from each target channel. For example, audio data generated from the captured radio signals may be transmitted to a remote streaming platform (also referred to as a “broadcast distribution” system), where it is accessible and/or otherwise distributed to remote user devices. In another example, audio data may be streamed directly to the remote user devices. Regardless, the disclosed system allows remote users (e.g., motorsports fans) to selectively stream desired channels (e.g., specific team or driver radios) from a personal device (e.g., their smartphone) without the need to buy, rent, and/or otherwise transport expensive and bulky radio equipment.

Notably, the disclosed system is capable of capturing and isolating multiple individual radio channels using far fewer radio receivers than existing designs. As mentioned above, for example, current technologies can require a 1:1 relationship between radio receivers and radio channels to be captured. In contrast, the disclosed system may utilize a single radio receiver from which audio of two or more channels-of-interest can be extracted, e.g., by employing a unique method of extracting multiple frequencies from a single signal (discussed below). This allows for an uneven relationship between radio receivers and radio channels (e.g., two or more channels per receiver). In one specific example, each radio receiver of the system is responsible for up to five channels of interest, but additional or fewer channels are also contemplated. As a result, the disclosed system is far less complex and much more compact than existing solutions, and with significantly reduced hardware costs.

The disclosed system is also software-configurable such that a non-expert user can easily and dynamically select the target channel(s) to be extracted. This allows the system to be rapidly deployed, without necessarily requiring an engineer or other expert for setup. For example, the radio receivers and on-site signal processing system may be at least partially self-contained such that the system can be readily (and even removably) installed at a location (e.g., a racetrack) with minimal or zero hardware configuration. Then, a user can locally or remotely configure the system (e.g., via software) based on the target channel(s) to be captured. This dynamic configurability contributes to additional reductions in complexity and cost while making the system much more user-friendly, which in turn increases accessibility, e.g., to smaller racing venues. In addition to the initial configuration, the system can also be dynamically reconfigured and/or controlled. For example, streams of certain channels of interest can be started or stopped at any time. Additional features and advantages of the disclosed system and methods will become clear based on the description below.

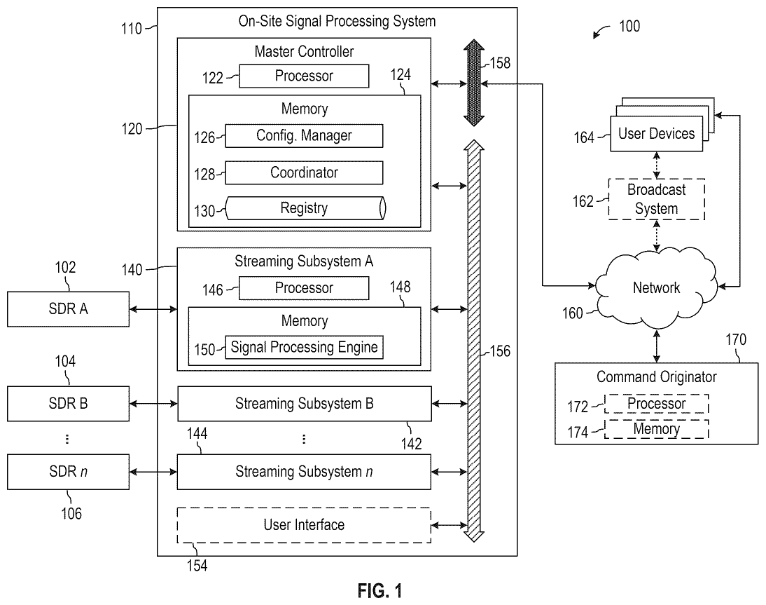

Referring to FIG. 1, a block diagram of a system 100 for capturing and streaming multiple radio channels is shown, according to some implementations. Generally, system 100 can be thought of as including “on-site” components that are configured to be deployed to a particular location during operation (e.g., a racetrack) and “off-site” or remote components that are not necessarily co-located with the on-site components. In other words, the on-site components of system 100 may be temporarily or permanently installed at a location where radio signals are to be captured (e.g., within a threshold distance of a source of the radio signal(s) of interest) while the off-site components are not necessarily limited in their physical position to the location of the on-site components. The on-site components generally include one or more radio receivers 102-106 and an on-site signal processing system 110, described in greater detail below. The off-site or remote components generally include a broadcast system 162 and/or a command originator 170, also described in greater detail below.

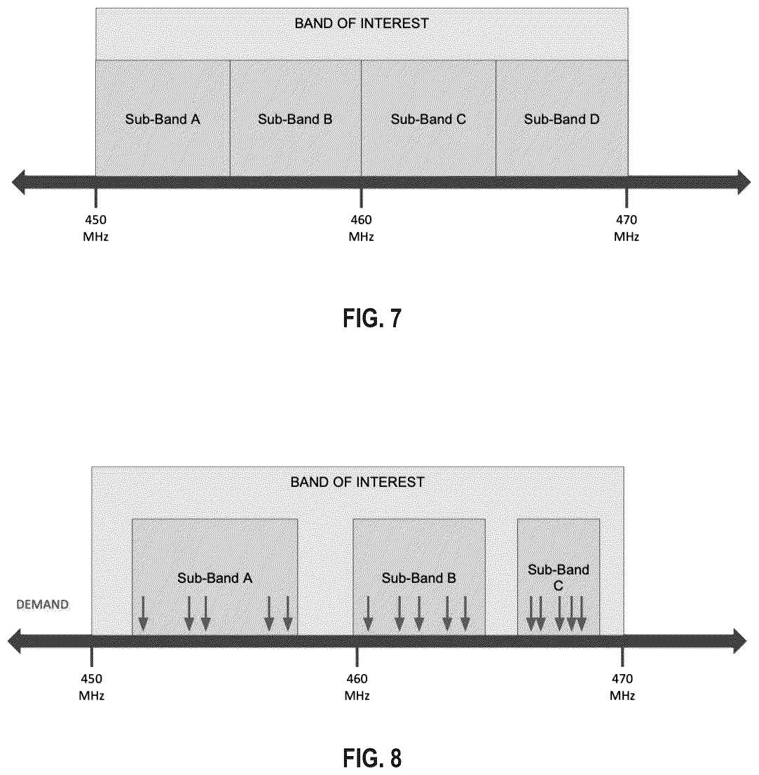

Radio receivers 102-106 are electronic devices or collection(s) of components configured to receive or “collect” radio waves, e.g., transmitted by some external broadcasting device. It will therefore be appreciated that radio receivers 102-106 can each include an antenna and corresponding electronic circuitry for receiving and processing radio waves. As described herein, radio receivers 102-106 may generally be configured to obtain radio waves within a frequency band-of-interest, e.g., which can be application-dependent. For use in receiving radio waves from driver and team radios (e.g., in motorsport), for example, radio receivers 102-106 may be configured to collectively obtain radio waves across an approximately 20 MHz band-of-interest (e.g., from about 450 MHz to 470 MHZ). To this point, in some implementations, radio receivers 102-106 are software-defined radios (SDRs) that can be configured (e.g., programmed) according to the frequencies or frequency range to be collected. Alternatively, in other implementations, radio receivers 102-106 are not reconfigurable but instead are each designed for sensitivity to a specific, predefined frequency range. Additional discussion of radio receivers 102-106 is provided below with respect to FIGS. 7-10.

On-site signal processing system 110 is generally configured to process radio signals obtained by radio receivers 102-106, ultimately generating audio data corresponding to the target channel(s) (e.g., specific frequencies within the frequency band-of-interest) and transmitting the audio data to at least one remote recipient (e.g., via Internet-based streaming). It should be noted here that the generation of the audio data by the on-site signal processing system 110, rather than transmitting the raw radio signals to some remote processor for processing, provides an advantage in its transmission requirements. While the raw radio signal can require up to 40 Megabytes per second (Mbps) of bandwidth to transmit, each audio channel may only require, for example, 40 kilobytes per second (Kbps), which is much more feasible for typical network systems. Additionally, on-site signal processing system 110 is shown to include a plurality of streaming subsystems—shown as streaming subsystem 140 (“Streaming Subsystem A”), streaming subsystem 142 (“Streaming Subsystem B”), and streaming subsystem 144 (“Streaming Subsystem n”)—each configured to receive a radio signal from a corresponding one of radio receivers 102-106 and to generate audio data as mentioned above. On-site signal processing system 110 can further include a master controller 120 for configuring and/or controlling streaming subsystems 140-144, and/or radio receivers 102-106, which is described below.

Streaming subsystems 140-144, as mentioned, receive a captured radio signal from at least one of radio receivers 102-106 (e.g., as an IQ stream) and generate corresponding audio data for one or more target channels. Notably, as discussed in greater detail below, the radio signal received by each of streaming subsystems 140-144 generally covers a range of frequencies (e.g., a 5 MHz range); therefore, each of streaming subsystems 140-144 is configured to isolate specific target channels (e.g., specific frequencies) from a respective received radio signal (e.g., where the target channels are within the frequency range of the corresponding radio receiver), generate audio data from the isolated channel(s), and transmit the generated audio data to a device external to on-site signal processing system 110. It should also be appreciated that the “radio signal” received by any of streaming subsystems 140-144 is generally a “stream” of radio signal data, e.g., continuously collected and transmitted by radio receivers 102-106. Further discussion of the functionality of streaming subsystems 140-144 is provided below.

In some implementations, each of streaming subsystems 140-144 includes at least one processor and memory, e.g., to perform various functions described below. For the sake of brevity, these components are shown in FIG. 1 and described herein with respect to streaming subsystem 140 only; however, it should be appreciated that streaming subsystems 142 and 144 generally also include the same or equivalent components. Alternatively, in other implementations, on-site signal processing system 110 includes at least one “master” processor and/or memory (not shown) that are shared by the various components thereof, e.g., such that streaming subsystems 140-144 do not require dedicated processor(s) and/or memory. In some such implementations, streaming subsystems 140-144 may represent software functions of on-site signal processing system 110 rather than physical components.

When contemplating implementations in which streaming subsystems 140-144 are physical components of on-site signal processing system 110, streaming subsystem 140 is shown to include a processor 146 and a memory 148. While shown as individual components, it will be appreciated that processor 146 and/or memory 148 can be implemented using a variety of different types and quantities of processors and memory. For example, processor 146 may represent a single processing device or multiple processing devices. Similarly, memory 148 may represent a single memory device or multiple memory devices. Processor 146 can be a general-purpose processor, an application-specific integrated circuit (ASIC), one or more field programmable gate arrays (FPGAs), a group of processing components (e.g., a central processing unit (CPU)), or other suitable electronic processing structures. In some implementations, processor 146 is configured to execute program code stored on memory 148 to cause streaming subsystem 140 to perform one or more operations, as described below in greater detail. It will be appreciated that, in some implementations (e.g., as mentioned above), the components of streaming subsystem 140 may be shared with, or the same as, the host device (e.g., on-site signal processing system 110).

Memory 148 can include one or more devices (e.g., memory units, memory devices, storage devices, etc.) for storing data and/or computer code for completing and/or facilitating the various processes described in the present disclosure. In some implementations, memory 148 includes tangible (e.g., non-transitory), computer-readable media that stores code or instructions executable by processor 146. Tangible, computer-readable media refers to any physical media that is capable of providing data that causes streaming subsystem 140 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 148 can include random access memory (RAM), read-only memory (ROM), erasable programmable read-only memory (EPROM), electronically erasable programmable read-only memory (EEPROM), hard drive storage, temporary storage, non-volatile memory, flash memory, optical memory, or any other suitable memory for storing software objects and/or computer instructions. Memory 148 can include database components, object code components, script components, or any other type of information structure for supporting the various activities and information structures described in the present disclosure. Memory 148 can be communicably connected to processor 146, such as via a processing circuit (not shown), and can include computer code for executing (e.g., by processor 146) one or more processes described herein.

Memory 148 is shown to include a signal processing engine 150 that processes the received radio signal(s) to generate audio data of one or more target channels. Generally, said audio data is generated responsive to a channel request, e.g., received from master controller 120 or command originator 170, as discussed below. Upon receiving a channel request, which indicates the target channel, signal processing engine 150 starts a new processing thread, isolates the target channel, and processes the isolated radio signal data to generate audio data. The generated audio data is then transmitted (e.g., “streamed”), e.g., to a remote recipient. In the configuration shown in FIG. 1, the audio data may be transmitted to a broadcast system 162, e.g., via a network 160, which facilitates Internet-based streaming of the audio data to any number of user devices 164. Alternatively, in some implementations, audio data is transmitted or “streamed” directly to user devices 164 via network 160. Network 160, broadcast system 162, and user devices 164 are all described in greater detail below.

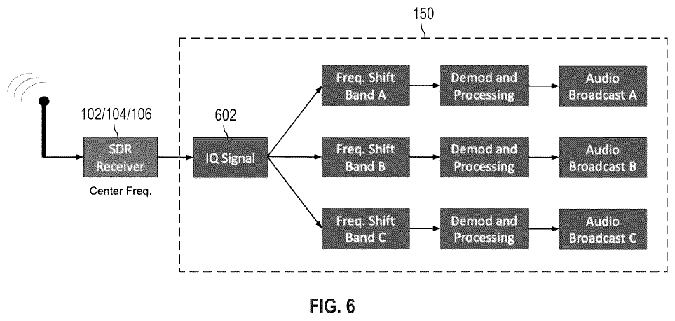

Additional reference is now made to FIG. 6, which illustrates the processing of a radio signal 602 collected by one of radio receivers 102-106, e.g., by signal processing engine 150. Radio signal 602 (e.g., an IQ signal), as alluded to above, generally covers a range of frequencies—called a frequency band—defined by a center frequency and/or sample rate of the radio receiver. In other words, the center frequency and sample rate of the radio receiver define the frequencies that the radio receiver receives and subsequently transmits (e.g., as radio signal 602) to signal processing engine 150. For a given frequency band-of-interest, multiple channels can be extracted from the same signal by processing, in parallel, radio signal 602 to isolate each individual channel. For each processing thread started by signal processing engine 150, the corresponding target channel is isolated, demodulated (e.g., as it is broadcast via frequency modulation (FM)), filtered (e.g., using a low-pass filter, for noise removal or compression, etc.), and output as an audio signal that can then be broadcast to end users.

One of the more notable features of system 100 is the ability to dynamically configure radio receivers 102-106 and/or streaming subsystems 140-144 based on one or more of: the frequency band-of-interest to be covered, the number of individual channels-of-interest (“target channels”) to be extracted, and/or the physical configuration (or processing limitations) of on-site signal processing system 110. Therefore, before continuing with the description of system 100, additional reference is made to FIGS. 7-10, which illustrate an example frequency band-of-interest and various techniques for dynamically configuring radio receivers 102-106 and/or streaming subsystems 140-144.

It is first important to understand how multiple channels can be extracted from the same signal, e.g., by signal processing engine 150, with more specificity. As mentioned above each of radio receivers 102-106 is initially set to a specific center frequency and sample rate, which determine the corresponding bandwidth based on the relationship fₛ/2 (e.g., as per the Nyquist frequency), where fs is the sample rate. Meanwhile, during the configuration of radio receivers 102-106, the center frequency can be set to baseband (0). In order to isolate a target channel, the signal (e.g., radio signal 602) is first shifted by the offset of the center frequency such that the target channel is at baseband. This can be accomplished using cosine-signal multiplication; however, it should be appreciated that other suitable techniques are contemplated. Subsequently, the target channel is isolated, e.g., using a low-pass filter (where the cutoff is set to half the channel bandwidth), followed by signal decimation (e.g., a form of lossless compression). Notably, for each processing thread started by signal processing engine 150, radio signal 602 can be separately frequency-shifted, demodulated, and processed, e.g., to generate multiple audio data streams in parallel (as shown in FIG. 6).

However, because the sample rate of a radio receiver (e.g., one of radio receivers 102-106) dictates its corresponding bandwidth, it should be appreciated that the sample rate of the radio receiver must increase to expand the bandwidth, e.g., according to the Nyquist frequency. Increasing the sample rate not only increases the cost of the equipment but also the cost and computational resources required to process a radio signal (e.g., radio signal 602). For example, processing 40 Mega samples per second (Msps) is much more difficult and computationally expensive than processing 10 Msps, especially when processing is done in parallel. In this example, isolating five target channels within a 40 Msps signal yields a total of 200 Msps that must be processed by signal processing engine 150. In contrast, isolating five target channels within a 10 Msps signal results in only 50 Msps to be processed.

Thus, as demonstrated in FIG. 7, the frequency band-of-interest may be broken up (e.g., parsed) into a number of smaller sub-bands that can be captured and processed individually. FIG. 7 shows, in particular, an example frequency band-of-interest covering a frequency range from 450 MHz to 470 MHz (e.g., corresponding to frequencies used by driver and team radios in motorsport) having four sub-bands labels “A” through “D.” It should be appreciated that the sub-bands do not necessarily need to be the same size (e.g., the same bandwidth) or to be mutually exclusive, nor do the sub-bands need to cover the entirety of the band of interest (e.g., if the entire frequency band-of-interest is not used). However, in this case, the sub-bands equally divide the example frequency band-of-interest. Each of radio receivers 102-106 can be configured to capture radio waves in a respective one of the sub-bands which, in turn, means that each of streaming subsystems 140-144 processes a signal (e.g., radio signal 602) covering only a portion of the overall frequency band-of-interest, thus reducing the computational resource requirements for each of streaming subsystems 140-144.

There are a number of different ways to optimize the configuration of radio receivers 102-106 and/or streaming subsystems 140-144, a few of which are shown in FIGS. 8-10. One such configuration technique is referred to herein as “quantile-based band setting,” shown in FIG. 8, in which the target channels are divided into two or more equal-sized or roughly equal-sized groups that define the sub-bands. In this implementation, the center frequency of two or more radio receivers is set as an average of the target channels in a respective one of the two or more sub-bands. However, other techniques of setting the center frequency are contemplated, such as minimizing a root mean squared (RMS) error between each of the target channels and the selected center frequency.

Suppose, for example, that there is a demand to broadcast fifteen target channels within a frequency band-of-interest, and that on-site signal processing system 110 is configured with three streaming subsystems (e.g., streaming subsystems 140-144), as illustrated in FIG. 8. In this case, the fifteen target channels (e.g., ordered by frequency) may be divided into three sub-bands. In conjunction, on-site signal processing system 110 could be configured such that streaming subsystem 140 processes a signal spanning a first sub-band (e.g., including the first five channels), streaming subsystem 142 processes a signal spanning a second sub-band (e.g., including the second five channels), and streaming subsystem 144 processes a signal spanning a third sub-band (e.g., including last first five channels). An advantage of this configuration is that each of radio receivers 102-106 can obtain better signal quality by reducing the gap between channel frequencies and the band center frequency (e.g., as it will be appreciated that the further a channel is from its receiver's center frequency, the worse the signal quality). Likewise, in cases where the bandwidth can be reduced, a smaller bandwidth means fewer computational resources are required.

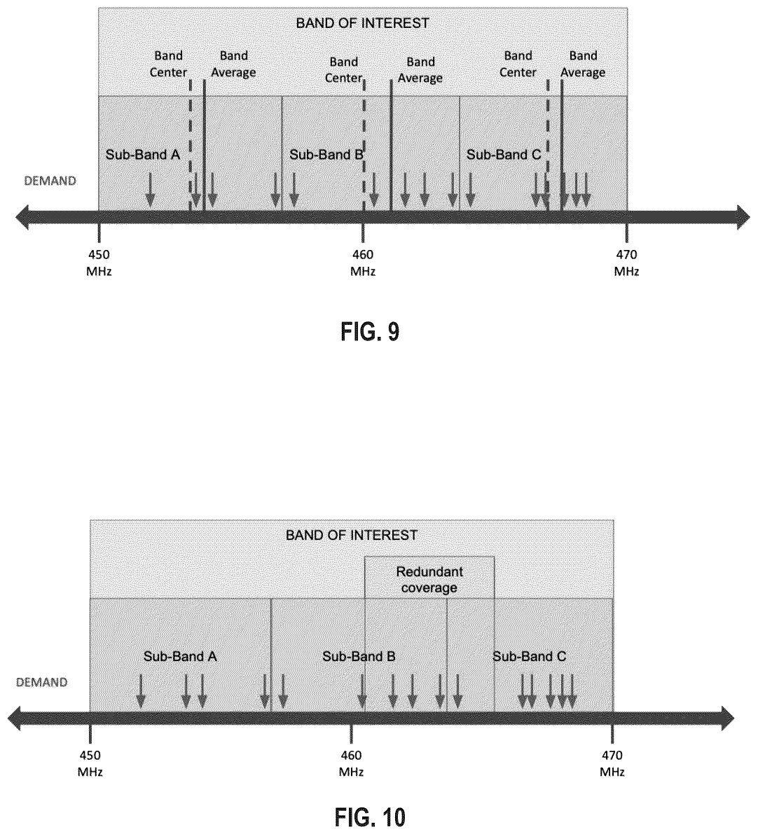

FIG. 9 illustrates another technique for configuring the center frequency and/or sampling rate of each of radio receivers 102-106, called “band-locked, averaged centering.” This technique is, in some respects, similar to quantile-based band setting as described above. However, a difference is which channels are used to determine the center frequency of each sub-band. Whereas in quantile-based band setting, the center frequency was chosen as the average of the first x channels, in band-locked, averaged centering each sub-band is “locked” to a predefined sub-band (e.g., 450 MHz to 455 MHZ), but is free to take the average of the target channels that fall within that band to determine a center frequency. For example, FIG. 9 shows four target channels falling within “Sub-Band A;” therefore, the center frequency of the radio receiver configured to capture “Sub-Band A” could be set to the center of the sub-band or an average of the four target channels that fall within the sub-band. In contrast, “Sub-Band B” is shown to include five target channels, and “Sub-Band C” six target channels, so the center frequencies of their respective radio receivers may have a different deviation from the band center.

FIG. 10 illustrates yet another technique configuring radio receivers 102-106 based on demand, referred to as “demand-based redundancy.” Suppose that there is extreme demand within one sub-band (e.g., 20 target channels) or high demand on the fringe of one or more sub-bands (which, as described above, would result in poor audio quality if handled by a single radio receiver). Demand-based redundancy allows for an extra radio receiver and/or an extra streaming subsystem to be allocated in these situations, to aid in processing the received signals. In FIG. 10, for example, a “redundant coverage” band is shown which spans “Sub-Band B” and “Sub-Band C,” e.g., such that the target channels that fall in the “redundant coverage” band are processed by a fourth radio receiver and/or streaming subsystem. One method for determining when to enable redundant coverage is by setting a maximum number of channels that can be handled by a radio receiver and/or streaming subsystem. If demand exceeds the maximum, a redundant radio receiver and/or streaming subsystem can be dynamically configured to handle any of the target channels that exceed the maximum. Another method is to set a threshold for the number of channel requests that can exist on the fringes of each sub-band (e.g., the “fringes” defined by separate thresholds), to identify when there occurs a large number of channels at the sub-band boundaries that have poor signal coverage.

Building on these aspects, it should therefore be appreciated that on-site signal processing system 110 can generally include any number of streaming subsystems and is not limited to what is shown in FIG. 1. For example, on-site signal processing system 110 can include only one streaming subsystem (e.g., streaming subsystem 140) or two or more streaming subsystems (e.g., up to n subsystem, where n is any positive integer). Likewise, system 100 can generally include any number of radio receivers. For example, system 100 may include one radio receiver corresponding to each of streaming subsystems 140-144 or may include fewer or additional radio receivers (e.g., one radio receiver may transmit a radio signal to two or more streaming subsystems) as discussed below. To this point, the specific configuration of system 100 may be selected to establish an economic balance between the number of streaming subsystems and the cost of radio receivers. For example, the number of streaming subsystems and/or radio receivers may be selected based on the size of the frequency band-of-interest to be covered and/or based on the number of channels-of-interest from which audio data is to be extracted.

Returning to FIG. 1, master controller 120 is shown to be in communication with streaming subsystems 140-144 via a communications bus 156. Likewise, although not explicitly illustrated, master controller 120 may communicate with radio receivers 102-106 via communications bus 156. As described herein, communications bus 156 facilitates the communication of data between the components of on-site signal processing system 110. The “communication” of data generally refers to the transmission and/or receipt of signals between the components of on-site signal processing system 110. Communications bus 156 can therefore be or include any suitable communication structure or components, and/or may include a combination of different structures/components to facilitate different communication protocols, signal types, etc. It should be appreciated that the present disclosure is not intended to be limiting in this regard.

Master controller 120 can further communicate with external devices and/or systems via a communications interface 158. Communications interface 158 can be or can include a wired or wireless communications interface (e.g., jacks, antennas, transmitters, receivers, transceivers, wire terminals, etc.) for conducting data communications, or a combination of wired and/or wireless communication interfaces. In some implementations, communications via communications interface 158 are direct (e.g., local wired or wireless communications) or via a network 160. As described herein, network 160 may be any type of public or private network, such as the Internet, a virtual private network (VPN), a wide area network (WAN), etc. Therefore, as an example, communications interface 158 may include one or more Ethernet ports for communicably coupling on-site signal processing system 110 to network 160 (e.g., the Internet). In another example, communications interface 158 can include a Wi-Fi transceiver for communicating via a wireless communications network to network 160. In yet another example, communications interface 158 may include cellular or mobile phone communications transceivers. It should be appreciated that the present disclosure is not intended to be limiting in this regard.

Master controller 120 is generally designed to control the configuration and/or operation of radio receivers 102-106 and/or streaming subsystems 140-144, as mentioned above. Specifically, master controller 120 is configured to receive and process channel requests (alternatively referred to herein as “streaming requests”), e.g., by determining which of streaming subsystems 140-144 should handle a received request and forwarding the request and/or commanding the selected streaming subsystem accordingly. Master controller 120 may also initially configure and/or dynamically reconfigure radio receivers 102-106, e.g., as discussed above with respect to FIGS. 7-10. Further details are provided below.

Master controller 120 is shown to include a processor 122 and a memory 124.

However, like streaming subsystems 140-144, it should be appreciated that master controller 120 may alternatively utilize a processor and/or memory that is shared by the components of on-site signal processing system 110 (not shown). Regardless, processor 122 can be a general-purpose processor, an ASIC, one or more FPGAs, a group of processing components (e.g., a CPU), or other suitable electronic processing structures. In some implementations, processor 122 is configured to execute program code stored on memory 124 to cause master controller 120 to perform one or more operations, as described below in greater detail. While shown as individual components, it will be appreciated that processor 122 and/or memory 124 can be implemented using a variety of different types and quantities of processors and memory. For example, processor 122 may represent a single processing device or multiple processing devices. Similarly, memory 124 may represent a single memory device or multiple memory devices.

Memory 124 can include one or more devices (e.g., memory units, memory devices, storage devices, etc.) for storing data and/or computer code for completing and/or facilitating the various processes described in the present disclosure. In some implementations, memory 124 includes tangible (e.g., non-transitory), computer-readable media that stores code or instructions executable by processor 122. Tangible, computer-readable media refers to any physical media that is capable of providing data that causes master controller 120 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 124 can include RAM, ROM, EPROM, EEPROM, hard drive storage, temporary storage, non-volatile memory, flash memory, optical memory, or any other suitable memory for storing software objects and/or computer instructions. Memory 124 can include database components, object code components, script components, or any other type of information structure for supporting the various activities and information structures described in the present disclosure. Memory 124 can be communicably connected to processor 122, such as via a processing circuit (not shown), and can include computer code for executing (e.g., by processor 122) one or more processes described herein.

Memory 124 is shown to include a configuration manager 126 that configures radio receivers 102-106 and/or streaming subsystems 140-144, e.g., as discussed above with respect to FIGS. 7-10. In particular, configuration manager 126 may initially configure radio receivers 102-106 and their respective streaming subsystems by setting (e.g., programming) each of radio receivers 102-106 with a center frequency and/or sample rate. In some such implementations, configuration manager 126 can determine the center frequency and/or sample rate of each of radio receivers 102-106 based on an indication of the frequency band-of-interest and/or the target channels that may be requested. For example, master controller 120 may be provided with an initial frequency band-of-interest and/or the target channels that may be requested via command originator 170 and/or an input to a user interface 154 (described below), which it then uses to determine how to configure radio receivers 102-106 (e.g., using the techniques described above). This allows radio receivers 102-106 to be dynamically configured, e.g., prior to an event and/or after being deployed to a location for capturing radio waves.

Notably, configuration manager 126 can also dynamically reconfigure radio receivers 102-106 and/or streaming subsystems 140-144, such as when target channels are added, when the frequency band-of-interest changes, based on target channel demand, etc. As discussed above with respect to FIG. 10, for example, configuration manager 126 can reconfigure radio receivers 102-106 if there is a high demand for specific target channels to avoid a decrease in audio quality, such as by activating a redundant radio receiver, reconfiguring the center frequency and/or sample rate of one of radio receivers 102-106 to assist with increased load, and the like.

Memory 124 is also shown to include a coordinator 128 that receives and processes streaming requests. A “streaming request,” as has been mentioned herein, is a request to stream audio of a target channel to a specific remote device (e.g., one of user devices 164). Generally, a streaming request includes an indication of the target channel and streaming instructions which, in part, provide an indicator for the recipient of the audio data (e.g., a broadcast ID or endpoint associated with broadcast system 162, or an ID associated with one of user devices 164). Streaming requests are generally received from command originator 170, as discussed below, but can also be received from other sources (e.g., via user interface 154). Optionally, as noted above, streaming requests can also be used to dynamically reconfigure radio receivers 102-106, e.g., based on demand.

Responsive to receiving a streaming request, coordinator 128 determines which of streaming subsystems 140-144 should handle the request, e.g., based on the target channel associated with the request. For example, coordinator 128 may determine which of the streaming subsystems 140-144 has the capacity to handle the request and/or which of the streaming subsystems 140-144 is associated with a frequency band (e.g., a sub-band) that includes the target channel. Coordinator 128 may then forward the request to the selected one of streaming subsystems 140-144 and/or may transmit a command to the selected one of streaming subsystems 140-144, to cause the selected subsystem to start a new processing thread, as discussed above. Coordinator 128 may further be configured to route the audio data generated by the selected subsystem to a recipient, e.g., by transmitting the audio data via network 160 to broadcast system 162 or a specific one of user devices 164.

In some implementations, coordinator 128 can also maintain a registry 130 that indicates the status of target channels. In particular, registry 130 may indicate which target channels are being actively broadcast (e.g., converted to audio and transmitted to remote recipients) so as to manage the activation and/or shut down of target channels. For example, if a shutdown request were to be received (e.g., due to a user ending a stream of a particular target channel, coordinator 128 may deactivate the target channel and update registry 130 accordingly. Likewise, when streaming requests are received, coordinator 128 may compare the request(s) against resource limitations, such as to deny requests when the maximum capacity of the device has been met, to deny out-of-band requests, etc.

While not explicitly shown, it should be appreciated that the components of on-site signal processing system 110, as described herein, may be combined into a single unit, e.g., for case of transportation, setup, and maintenance. For example, on-site signal processing system 110 may further include a housing or enclosure that contains master controller 120, streaming subsystems 140-144, and so on. In some implementations, radio receivers 102-106 are also at least partially enclosed in the same housing as on-site signal processing system 110 and/or are mounted/attached to the housing of on-site signal processing system 110. In this manner, the “on-site” components of system 100 may be at least partially self-contained, again to make transportation and set up much easier for non-expert users. For example, the “on-site” components of system 100 may be shipped or otherwise transported to a location as a single unit, and then may be easily connected to power and network 160 by any user.

Broadcast system 162, as mentioned, is generally a system or platform (e.g., a software program) for streaming audio data to user devices 164. In other words, broadcast system 162 is configured to receive audio data from on-site signal processing system 110 so that it is accessible to user devices 164 for streaming to individual devices, e.g., via an application or a web browser. Generally, broadcast system 162 is external to on-site signal processing system 110. For example, broadcast system 162 may be an Internet-based streaming platform. However, certain implementations are envisioned in which broadcast system 162 is part of on-site signal processing system 110. User devices 164 generally include any number of electronic devices that are operable by users (e.g., motorsports fans) to receive streaming audio. For example, user devices 164 can include smartphones, smart watches, personal computers, tablets, and the like. In some implementations, audio streams can be received directly from on-site signal processing system 110 rather than from broadcast system 162. As described herein, broadcast system 162 and/or user devices 164 may be referred to as “remote recipients” of the audio data generated by on-site signal processing system 110.

Command originator 170 is a remote device or platform configured to generate streaming requests and subsequently send them to on-site signal processing system 110. In this regard, command originator 170 can dynamically start and/or stop audio streams based on user demand. For example, responsive to receiving a request from a user, command originator 170 can cause on-site signal processing system 110 to start a new audio stream and/or when a user ends a stream (e.g., by closing the app or switching to another channel), command originator 170 may cause on-site signal processing system 110 to end the associated audio stream. Such streaming requests can be initiated by a user, e.g., of user devices 164, via an application (e.g., a smartphone “app”) or a web browser. For example, a user may select a particular radio channel (e.g., a “target channel”) they want to stream via a user interface on their personal device, which in turn sends an indication of the selected radio channel to command originator 170. Command originator 170 can then generate a streaming request that includes the target channel and streaming instructions, e.g., including an identifier or address related to the user's device, for routing the generated audio. To this point, command originator 170 may be configured to receive or determine an identifier (e.g., a phone number, an address, an ID, etc.) associated with the user device making the request so that the audio data can be routed appropriately. Additionally, or alternatively, command originator 170 may be configured to generate a broadcast channel ID for each streaming request so that the audio data can be properly routed to one of user devices 164. Thus, the command originator 170 coordinates the generation of audio data from the one or more the streaming subsystems 140-144 and its transmission to the user devices 164.

In addition to generating streaming requests, command originator 170 may be configured to send configuration information and/or instructions to on-site signal processing system 110, e.g., during an initial setup of on-site signal processing system 110. In this manner, command originator 170 may act as a remote controller of on-site signal processing system 110, allowing a user or users to set up on-site signal processing system 110 remotely. For example, an operator or owner of on-site signal processing system 110 may remotely access on-site signal processing system 110 via command originator 170, e.g., to set the frequency band-of-interest and/or target channels. In turn, on-site signal processing system 110 can use the received configuration data to set radio receivers 102-106 appropriately, as discussed above. In this way, the command originator 170 can take on the responsibility of maintaining and mapping radio frequencies to specific channels of interest. For example, the command originator 170 may maintain known radio frequencies of drivers and teams that may participate in a particular racing event, such that users may only need to request access to the audio stream of a particular driver or team by name, without having to know the driver or team's specific radio frequency.

As described herein, command originator 170 refers to a cloud server, an Internet-based platform hosted on a cloud server, or the like, in various implementations. In other implementations, command originator 170 can be local to on-site signal processing system 110 (e.g., implemented via user interface 154). It should therefore be appreciated that command originator 170 may be a physical device or may be a virtual platform (e.g., which may be hosted on a physical device, such as a server). It should also be appreciated that command originator 170 may be in communication with user devices 164 via network 160.

In implementations where command originator 170 is a physical device, command originator 170 may include a processor 172 and memory 174. Alternatively, processor 172 and memory 174 may represent a processor and server of a host device, such as a cloud server. While shown as individual components, it will be appreciated that processor 172 and/or memory 174 can be implemented using a variety of different types and quantities of processors and memory. For example, processor 172 may represent a single processing device or multiple processing devices. Similarly, memory 174 may represent a single memory device or multiple memory devices. Processor 172 can be a general-purpose processor, an ASIC, one or more FPGAs, a group of processing components (e.g., a CPU), or other suitable electronic processing structures. In some implementations, processor 172 is configured to execute program code stored on memory 174 to cause command originator 170 to perform one or more operations, as described below in greater detail. It will be appreciated that, in implementations where command originator 170 is part of or hosted on another computing device, the components of command originator 170 may be shared with, or the same as, the host device. For example, if command originator 170 is implemented via a cloud server, as mentioned above, then command originator 170 may utilize the processing circuit, processor(s), and/or memory of the cloud server to perform the functions described herein.

Memory 174 can include one or more devices (e.g., memory units, memory devices, storage devices, etc.) for storing data and/or computer code for completing and/or facilitating the various processes described in the present disclosure. In some implementations, memory 174 includes tangible (e.g., non-transitory), computer-readable media that stores code or instructions executable by processor 172. Tangible, computer-readable media refers to any physical media that is capable of providing data that causes command originator 170 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 174 can include RAM, ROM, EPROM, EEPROM, hard drive storage, temporary storage, non-volatile memory, flash memory, optical memory, or any other suitable memory for storing software objects and/or computer instructions. Memory 174 can include database components, object code components, script components, or any other type of information structure for supporting the various activities and information structures described in the present disclosure. Memory 174 can be communicably connected to processor 172, such as via a processing circuit (not shown), and can include computer code for executing (e.g., by processor 172) one or more processes described herein.

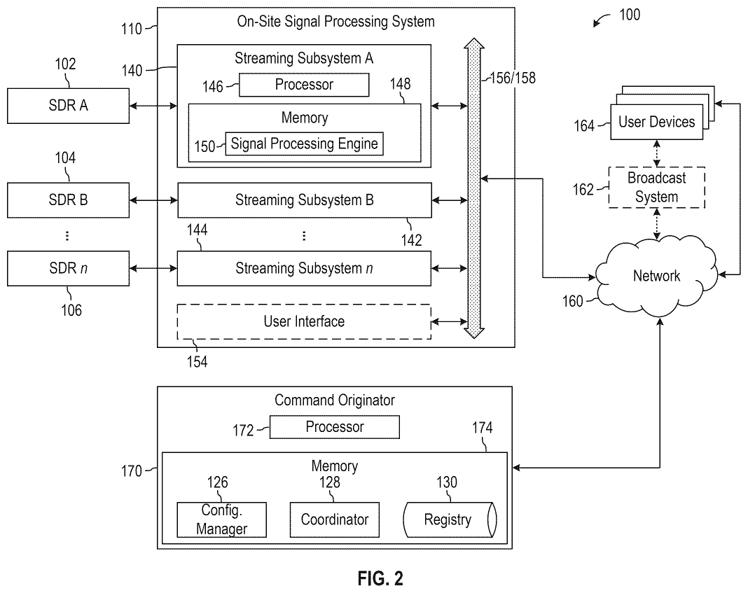

Turning briefly to FIG. 2, an alternate configuration of system 100 is shown which does not include master controller 120, according to some implementations. Instead, in this configuration, command originator 170 fills the role of master controller 120, e.g., in addition to its other functions as discussed above; however, the other functionality of on-site signal processing system 110 and the components thereof remains the same. In this regard, command originator 170 may handle all of the generation of streaming requests to start/stop audio streams, the configuration and/or reconfiguration of the components of on-site signal processing system 110, and the coordination of streaming request, e.g., to the various streaming subsystems. This alternative configuration can, in some cases, further reduce the cost, size, and complexity of on-site signal processing system 110 by moving the above-mentioned functions off-site (e.g., remote), which means that on-site signal processing system 110 requires fewer computational resources.

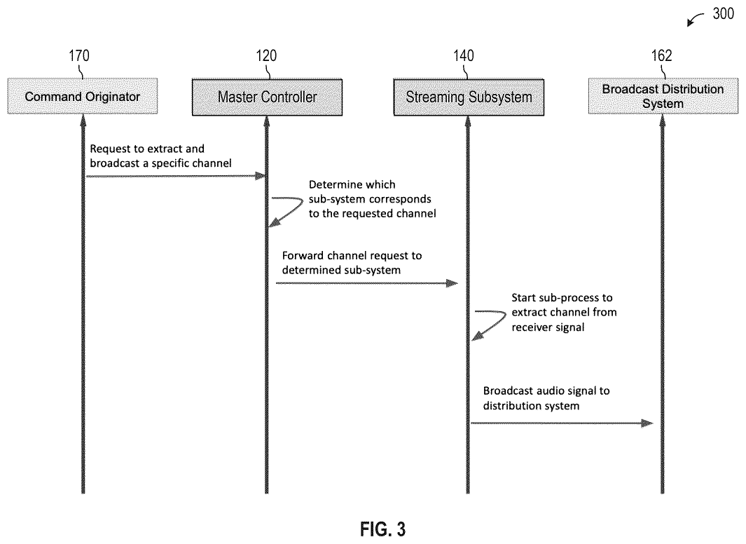

Referring now to FIG. 3, a diagram of a communication architecture 300, which illustrates the transfer of data between components of system 100 when processing a streaming request, is shown, according to some implementations. Initially, although not explicitly illustrated, command originator 170 receives an indication and/or otherwise determines that a user wants to start streaming a particular radio channel (e.g., a target channel). For example, the user may select one of a plurality of predefined target channels via their personal electronic device, enter a particular channel identifier (e.g., a frequency) via their personal electronic device, or the like, which is then transmitted to or otherwise obtained by command originator 170. As noted above, for example, command originator 170 may be accessible to user devices 164 via a web browser, a dedicated application, or the like, so user requests may be directly received by command originator 170 and/or transmitted from one of user devices 164 to command originator 170.

Regardless, upon receiving an indication that a user wants to stream a particular channel, command originator 170 generates a streaming request and sends the streaming request to on-site signal processing system 110. In this example, the streaming request is sent to master controller 120, in particular; however, it should be appreciated that command originator 170 may alternatively send the request directly to one of streaming subsystems 140 (e.g., as in the configuration shown in FIG. 2). Master controller 120, upon receiving the streaming request, determines which of streaming subsystems 140-144 should handle the request. Generally, this is determined by the target channel indicated in the request, where master controller 120 selects the streaming subsystem that covers the corresponding frequency range (e.g., sub-band), e.g., as determined by the configuration of the corresponding radio receiver. Master controller 120 then forwards the streaming request to the selected one of streaming subsystems 140-144 and/or sends a command to the selected one of streaming subsystems 140-144.

Responsive to receiving the streaming request and/or a command, the selected streaming subsystem—in this case, streaming subsystem 140—then initiates a subprocess to isolate the target channel from a combined radio signal, e.g., provided by radio receiver 102. As discussed above, this “subprocess” generally includes isolating the target frequency (e.g., by frequency shifting the radio signal to set the target channel as the center frequency) and demodulating and processing (e.g., filtering) the portion of the radio signal at the target channel to generate audio data. Streaming subsystem 140 then broadcasts (e.g., transmits) the generated audio data to broadcast system 162 or, alternatively, directly to a user device of the user that initiated the request.

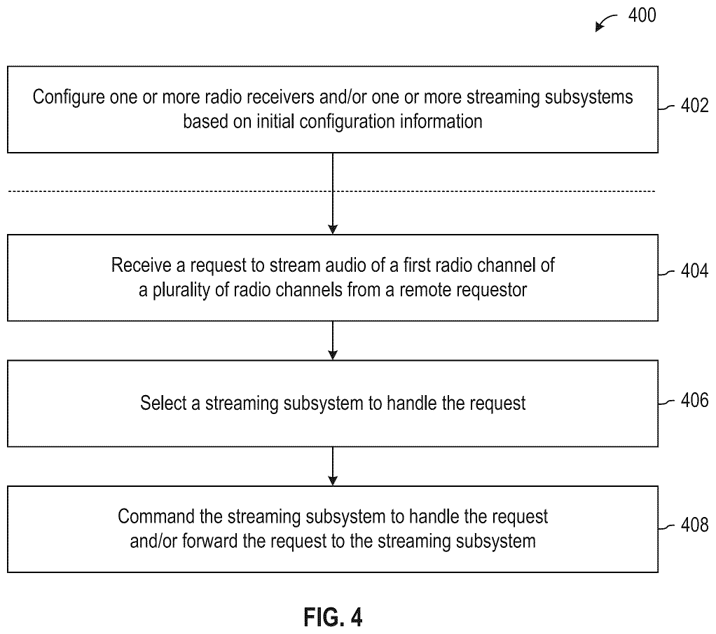

Referring now to FIG. 4, a flow chart of a process 400 for dynamically configuring multiple radio receivers and initiating the extraction of audio data from target channels is shown, according to some implementations. Process 400 can be generally implemented by system 100, as described above, or more specifically by on-site signal processing system 110 and/or command originator 170, in some implementations. It will be appreciated that certain steps of process 400 may be optional and, in some implementations, process 400 may be implemented using less than all of the steps. It will also be appreciated that the order of steps shown in FIG. 4 is not intended to be limiting.

At step 402, one or more radio receivers (e.g., radio receivers 102-106) and/or their associated streaming subsystems (e.g., streaming subsystems 140-144) are configured based on initial configuration information. As discussed above, this initial configuration generally includes setting a center frequency and sampling rate of each of radio receivers 102-106, thereby defining the frequency range (e.g., sub-band) that each radio receiver receives. In some implementations, the initial configuration information includes a frequency band-of-interest and/or an indication of predefined target channels, which can be used to determine the necessary sub-bands. In turn, the center frequency and sampling rate of each of radio receivers 102-106 can be calculated from the determined sub-bands using any of the techniques described above; however, it will be appreciated that other suitable methods of determining a center frequency and sampling rate of each of radio receivers 102-106 are contemplated herein.

It should be appreciated that step 402 of process 400 may be performed once, e.g., during setup of system 100, but the remaining steps of process 400 may be repeated as described below. However, the one or more radio receivers (e.g., radio receivers 102-106) and/or their associated streaming subsystems (e.g., streaming subsystems 140-144) may also be dynamically reconfigured, e.g., at any point in process 400. Reconfiguration can similarly include adjusting the center frequency and/or sampling rate of any of radio receivers 102-106, as discussed above. In some implementations, reconfiguration can include activating an additional (e.g., redundant) radio receiver and setting the additional radio receiver's center frequency and/or sampling rate. Additional description of such dynamic reconfiguration is provided above.

At step 404, a request to stream audio of a first radio channel is received from a remote requestor. The request-referred to herein as a streaming request-generally includes an indicator of the first radio channel, such as a frequency or channel ID, and may optionally include steaming instructions that dictate streaming parameters (e.g., bit rate, etc.) and/or indicate a recipient of the audio steam. In some implementations, the first or “target” radio channel is one of a plurality of predefined radio channels. In other implementations, the first or “target” radio channel is any channel that falls within a frequency band-of-interest. The remote requestor may be any remote device or other platform (e.g., a web browser or cloud platform) in communication with on-site signal processing system 110 and configured to generate streaming requests. As described above, for example, the remote request may be command originator 170 and/or one of user devices 164. In some such implementations, streaming requests may be generated by command originator 170 responsive to a user input via a respective one of user devices 164.

At step 406, a streaming subsystem is selected to handle the request. Notably, as discussed above, on-site signal processing system 110 may include one or more streaming subsystems 140-144, each configured to process radio signals from at least one of radio receivers 102-106. Therefore, each of streaming subsystems 140-144 may be configured to process radio signals within a particular sub-band of the frequency band-of-interest, e.g., as determined by the center frequency and sampling rate of the respective radio receiver. For example, in a configuration with two radio receivers, one set to cover a 450-455 MHz sub-band and the other to cover a 455-460 MHz sub-band, on-site signal processing system 110 may include two active streaming subsystems-one to process the 450-455 MHz radio signal and the other to process the 455-460 MHz radio signal. To determine which of the streaming subsystems should handle the request, master controller 120 or command originator 170 may determine which of the streaming subsystems 140-144 is configured to process radio signals within a frequency range that covers the target channel defined by the streaming request. As noted above, if none of the radio receivers 102-106 and/or streaming subsystems 140-144 are set up accordingly, a new or redundant radio receiver and/or streaming subsystem may be dynamically configured to handle the streaming request, or an already active radio receiver and/or streaming subsystem may be reconfigured to handle the streaming request.

At step 408, the selected streaming subsystem is commanded to handle the request and/or the request is forwarded to the selected streaming subsystem. Responsive to receiving the command and/or the streaming request itself, the selected streaming subsystem (e.g., one of streaming subsystems 140-144) may start a new processing thread to isolate the target channel from a received radio signal (e.g., which covers a range of frequencies defined by the sub-band, as discussed above) and generate audio data of the target channel. Then, the audio data may be streamed to a remote recipient, which can be the same as the remote requestor or different. For example, the selected streaming subsystem may transmit the audio data to broadcast system 162 or directly to one of user devices 164. Alternatively, the audio data may be transmitted by the selected streaming subsystem to master controller 120 or command originator 170, for forwarding to the remote recipient.

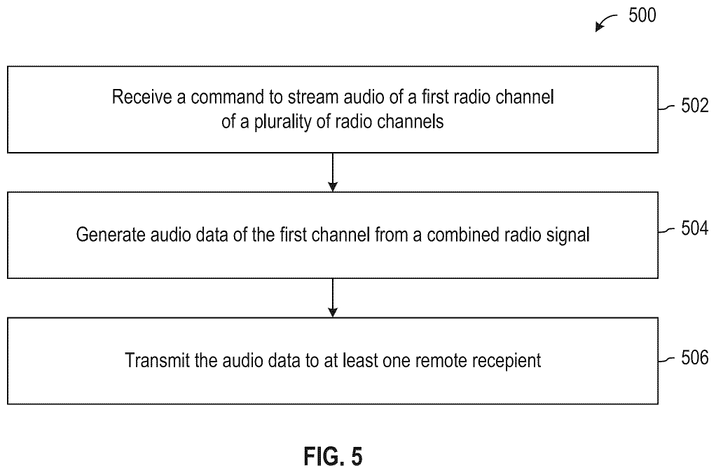

Referring now to FIG. 5, a flow chart of a process 500 for selectively extracting audio data from target channels is shown, according to some implementations. Process 500 can be generally implemented by system 100, as described above, or more specifically by any of streaming subsystems 140-144, in some implementations. It will be appreciated that certain steps of process 500 may be optional and, in some implementations, process 500 may be implemented using less than all of the steps. It will also be appreciated that the order of steps shown in FIG. 5 is not intended to be limiting.

At step 502, a request or command to stream audio of a first radio channel is received, e.g., by one of streaming subsystems 140-144. In the context of process 500, the request or command may be received from master controller 120 or command originator 170. In cases where the request itself is received, the request (e.g., a “streaming” request”) generally includes an indicator of the first radio channel, such as a frequency or channel ID, and may optionally include steaming instructions that dictate streaming parameters (e.g., bit rate, etc.) and/or indicate a recipient of the audio steam, as discussed above. Alternatively, as mentioned, master controller 120 or command originator 170 may send a command to the selected streaming subsystem rather than forwarding the request. In such implementations, the command may likewise indicate the first (“target”) radio channel to be streamed. Receiving either a request or command causes the streaming subsystem to initiate a processing thread to generate the requested audio steam.

At step 504, audio data of the first radio channel is generated from a combined radio signal responsive to receiving the request or command. In particular, the streaming subsystem that receives the request/command initiates a processing thread to isolate the first radio channel from a radio signal received from a corresponding radio receiver (e.g., an IQ steam) and covert the isolated first radio channel signal to digital audio. In some implementations, this process can more specifically include isolating a portion of the radio signal associated with the first channel (e.g., via frequency shifting), demodulating the portion of the radio signal associated with the first channel, and optionally filtering the portion of the radio signal associated with the first channel (e.g., low-pass filter, noise removal, compression, etc.) to produce the audio data.

At step 506, the audio data is then transmitted to at least one remote recipient. The remote recipient may be any remote device or platform, such as broadcast system 162 or one of user devices 164. In some implementations, the audio data is transmitted to the to at least one remote recipient directly from the streaming subsystem the generated the audio data. Alternatively, in some implementations, the audio data is transmitted by the streaming subsystem to one of master controller 120 or command originator 170, e.g., to limit the number of components of on-site signal processing system 110 that have access to network 160 (e.g., the Internet).

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A system comprising:
a first signal processing subsystem in communication with a first radio receiver, the first signal processing subsystem configured to selectively generate audio data of individual radio channels within a first frequency range of radio signals captured by the first radio receiver;
a second signal processing subsystem in communication with a second radio receiver, the second signal processing subsystem configured to selectively generate audio data of individual radio channels within a second frequency range of radio signals captured by the second radio receiver, the second frequency range different from the first frequency range; and
a controller in communication with the first and second signal processing subsystems, wherein the controller is configured to: (i) receive a streaming request from a remote requestor, the streaming request indicating a target radio channel and comprising instructions for streaming audio data associated with the target radio channel to a remote recipient, and (ii) configure one of the first or second signal processing subsystems to fulfill the streaming request based on the target radio channel and the first and second frequency ranges;
wherein, responsive to configuration by the controller, the one of the first or second signal processing subsystems configured to fulfill the streaming request generates audio data of the target radio channel from the radio signals captured by a respective one of the first or second radio receivers, and wherein the generated audio data is transmitted to the remote recipient.

2. The system of claim 1, wherein the target radio channel is one of a plurality of predefined target radio channels within a frequency band of interest, wherein prior to receiving the streaming request, the controller is further configured to:
parse the frequency band of interest into a plurality of sub-bands according to the plurality of predefined target radio channels, wherein a first one of the plurality of sub-bands defines the first frequency range and a second one of the plurality of sub-bands defines the second frequency range, and wherein each of the plurality of sub-bands comprises at least one of the plurality of predefined target radio channels; and
configure at least one of: (i) the first radio receiver to capture radio signals in the first one of the plurality of sub-bands, or (ii) the second radio receiver to capture radio signals in the second one of the plurality of sub-bands.

3. The system of claim 2, wherein configuring a radio receiver of the plurality of radio receivers according to its respective sub-band includes to:
set or adjust a sampling rate of the radio receiver according to a bandwidth of the respective sub-band, wherein a center frequency of the respective sub-band is selected based on one of: (i) an average of any of the plurality of predefined target radio channels in the respective sub-band, or (ii) by minimizing a root mean squared (RMS) error between any of the plurality of predefined target radio channels in the respective sub-band.

4. The system of claim 1, wherein responsive to receiving the streaming request, the controller is further configured to:
determine a sub-band within a frequency band of interest that includes the target radio channels, wherein the sub-band defines one of the first frequency range or the second frequency range; and
configure at least one of the first or second radio receivers to capture radio signals in the sub-band.

5. The system of claim 1, wherein the controller is further configured to maintain a registry of active audio streams, including to update the registry when streaming of the audio data from the target radio channel is active.

6. The system of claim 1, wherein to generate the audio data, the one of the first or second signal processing subsystems selected to handle the streaming request:
isolates a portion of the first or second radio signals associated with the first channel via frequency shifting;
demodulates the portion of the first or second radio signals associated with the first channel; and
filters the demodulated portion of the of the first or second radio signals.

7. The system of claim 1, wherein the instructions include an identifier associated with the remote recipient.

8. The system of claim 1, wherein at least one of the first radio receiver or the second radio receiver is a software-defined radio.

9. The system of claim 1, wherein the remote recipient is one of an Internet-based audio streaming platform or a personal computing device.

10. The system of claim 1, wherein the remote requestor a cloud-based controller.

11. A method of selectively streaming audio data from multiple radio channels, the method comprising:
continuously capturing, by a plurality of radio receivers, radio signals across a frequency band of interest, each of the plurality of radio receivers configured to capture a subset of the radio signals in a respective sub-band of the frequency band of interest;
receiving, from a remote requestor, a streaming request indicating a target radio channel from which audio data is to be generated and streamed;
configuring a first signal processing subsystem of a plurality of signal processing subsystems to fulfill the streaming request, wherein each of the plurality of signal processing subsystems is configured to receive a respective subset of the radio signals from a corresponding one of the plurality of radio receivers and selectively generate audio data of individual radio channels within a respective sub-band, and wherein the first signal processing subsystem is configured to fulfill the streaming request based on its respective sub-band and the target radio channel;
generating, by the first signal processing subsystem, the audio data of the target channel by, in part, isolating a portion of the subset of the radio signals received by the first signal processing subsystem corresponding to the target channel via frequency shifting; and
transmitting the audio data to a remote recipient.

12. The method of claim 11, wherein the target radio channel is one of a plurality of predefined target radio channels, the method further comprising:
prior to continuously capturing the radio signals:
parsing the frequency band of interest into a plurality of sub-bands according to the plurality of predefined target radio channels; and
configuring each of the plurality of radio receivers according to their respective sub-band of the plurality of sub-bands.

13. The method of claim 12, wherein configuring a radio receiver of the plurality of radio receivers according to its respective sub-band comprises:
setting or adjusting a sampling rate of the radio receiver to correspond to a bandwidth of the respective sub-band, wherein a center frequency of the respective sub-band is selected based on one of: (i) an average of any of the plurality of predefined target radio channels in the respective sub-band, or (ii) by minimizing a root mean squared (RMS) error between any of the plurality of predefined target radio channels in the respective sub-band.

14. The method of claim 11, further comprising:
responsive to receiving the streaming request:
determining a sub-band within a frequency band of interest that includes the target radio channel; and
reconfiguring one of the plurality of radio receivers to capture radio signals in the sub-band.

15. The method of claim 11, further comprising:
maintaining a registry of active audio streams, including updating the registry when streaming of the audio data from the target radio channel is active.

16. The method of claim 11, wherein generating the audio data further comprises:
demodulating the isolated portion of the subset of the radio signals received by the selected signal processing subsystem corresponding to the target channel; and
filtering the demodulated portion of the subset of the radio signals received by the selected signal processing subsystem corresponding to the target channel.

17. The method of claim 11, wherein the streaming request further includes streaming instructions, the streaming instructions indicating an identifier associated with the remote recipient.

18. The method of claim 11, wherein the remote recipient is one of an Internet-based audio streaming platform or a personal computing device.

19. The method of claim 11, wherein the remote requestor a cloud-based controller.

20. A system comprising:
at least one radio receiver configured to capture a radio signal that covers a first frequency range;
at least one processor; and
memory having instructions stored thereon that, when executed by the at least one processor, cause the system to:
receive, from a remote requestor, a request to stream audio data from a first channel within the first frequency range, wherein the request includes an identifier of the first channel and instructions for streaming the audio data to a remote recipient;
generate the audio data of the first channel from the radio signal by: (i) isolating a portion of the radio signal associated with the first channel via frequency shifting, (ii) demodulating the portion of the radio signal associated with the first channel, and (iii) filtering the demodulated portion of the radio signal associated with the first channel; and
transmit the audio data to the remote recipient, wherein the remote recipient is one of a cloud-based audio streaming platform or a user device.
